(19) United States
(12) Patent Application Publication
(10) Pub. No.: US 2025/0053786 A1
(43) Pub. Date: Feb. 13, 2025

(54) GENERATING DISCRETE DATA USING DIFFUSION NEURAL NETWORKS

(71) Applicant: Google LLC, Mountain View, CA (US)

(72) Inventors: Ting Chen, Mountain View, CA (US); Ruixiang Zhang, Lasalle (CA); Geoffrey E. Hinton, Toronto (CA)

(21) Appl. No.: 18/366,638

(22) Filed: Aug. 7, 2023

(51) Int. Cl. G06N 3/0455

(52) U.S. Cl. CPC G06N 3/0455

(57) ABSTRACT

Methods, systems, and apparatus, including computer programs encoded on a computer storage medium, for generating a network output of high dimensional data comprising one or more output tokens. In one aspect, a system comprises a neural network system configured to initialize an analog bit representation of the network output comprising a set of continuous numeric values for each of the output tokens. The neural network system generates an updated analog bit representation that comprises a set of updated continuous numeric values. At each of a plurality of update iterations, the neural network system processes a diffusion input comprising the analog bit representation using a diffusion machine learning model to update the analog bit representation.

### BACKGROUND

This specification relates to a method for generating data using diffusion machine learning models.

Machine learning models receive an input and generate an output, e.g., a predicted output, based on the received input and on values of the parameters of the model.

### SUMMARY

This specification describes how a system can generate data using diffusion machine learning models.

According to a first aspect, there is provided a method performed by one or more data processing apparatus for generating a network output including one or more output tokens. The method includes initializing an analog bit representation of the network output that includes a respective set of continuous numeric values for each of the output tokens and generating an updated analog bit representation that includes a respective set of updated continuous numeric values for each of the output tokens. The generating includes, at each of multiple update iterations, processing a diffusion input including the analog bit representation using a diffusion machine learning model to update the analog bit representation, and, for each output token, generating a binary representation of the output token by generating, from each updated continuous value in the set of respective continuous values for the output token, a corresponding binary value, and generating the output token by decoding the binary representation of the output token.

In some implementations, the network output is conditioned on a network input including one or more input tokens, where initializing the analog bit representation of the network output further includes generating a respective set of continuous numeric values representing each of the input tokens, and where the analog bit representation includes the respective sets of continuous numeric values representing each of the input tokens and the respective sets of continuous numeric values representing each of the output tokens

In some implementations, the network output is conditioned on a network input, and the method also includes processing the network input using an encoder neural network to generate an encoded representation of the network input, and where at each update iteration, the diffusion model is conditioned on the encoded representation of the network input.

In some implementations, generating the binary representation of the output token includes quantizing each continuous value using a threshold to generate the corresponding binary value.

In some implementations, processing the diffusion input including the analog bit representation using a diffusion machine learning model to update the analog bit representation further comprises, at each of the multiple iterations, processing a diffusion input for the update iteration that includes the analog bit representation as of the update iteration using the diffusion machine learning model to generate a denoising output that defines an update to the analog bit representation, and updating the analog bit representation as of the update iterating using the denoising output.

In some implementations, the diffusion input for the update iteration includes the analog bit representation as of the update iteration and the denoising output generated by the diffusion machine learning model at a preceding update iteration.

In some implementations, the diffusion input for the update iteration includes an identifier for a time step corresponding to the update iteration, and where time intervals between the time steps corresponding to the update iterations are asymmetric.

In some implementations, the denoising output is an estimate of a noise component of a final analog bit representation.

In some implementations, for each output token, the set of binary values has a respective value for each output of a vocabulary of output tokens and includes only one non-zero value.

In some implementations, the method further includes setting the output token to be the output token from the vocabulary that corresponds to the non-zero value.

In some implementations, for each output token, the binary representation of the output token is a representation of a number in a base-2 number system.

In some implementations, the method further includes setting the output token to be an output token from a vocabulary that is identified by the number in the base-2 number system.

The subject matter described in this specification can be implemented in particular embodiments so as to realize one or more of the following advantages.

Some conventional systems use autoregressive modeling techniques to generate discrete outputs. Autoregressive modeling includes training neural networks, such as Transformer neural networks, to generate discrete outputs by generating each discrete token of the discrete auto-regressively, i.e., one by one conditioned on all already generated tokens. Though autoregressive modeling allows for generation of high quality discrete outputs, generating high dimensional discrete outputs requires a large amount of computational resources due to the one-by-one generation. That is, autoregressive models are only able to generate one output token of discrete data at a time, so generating large amounts of output tokens requires significant computational resources and increases the latency of generating discrete outputs. Additionally, the amount of computational resources consumed (and the latency) increases with the number of tokens in the discrete output.

Diffusion models are another type of generative model that have desirable properties for mitigating the latency and computational inefficiency related to generating high-dimensional outputs. However, diffusion models operate in a continuous space and, therefore, diffusion models cannot be directly applied for generating discrete outputs.

In contrast, this specification describes techniques that allow diffusion models to be used for generating discrete data, e.g., high dimensional discrete data, by using a trained diffusion model to effectively generate discrete data without modifying the underlying diffusion model. By effectively generating the output tokens of discrete data using a diffusion model that operates in continuous space using an analog bit representation of the discrete output, the system can decrease latency in generating high dimensional discrete data by leveraging the efficiency of the model. For example, the described analog bit techniques can be used to allow a continuous space diffusion model to effectively generate discrete text tokens, e.g., for natural language text generation, or to generate images with discrete intensity values, or to generate high-dimensional, discrete image processing outputs, e.g., image segmentation outputs.

Additionally, this specification describes a self-conditioning technique, which can be applied to generate either discrete or continuous data. Self-conditioning allows for improved sample quality when generating network outputs and can allow for more accurate generation of high dimensional data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a block diagram of an example system for training a diffusion model and sampling high dimensional discrete data.

FIG. 3 is a flow diagram for generating high dimensional discrete data using a diffusion model.

FIG. 4 is a diagram of diffusion model implementations.

Like reference numbers and designations in the various drawings indicate like elements.

### DETAILED DESCRIPTION

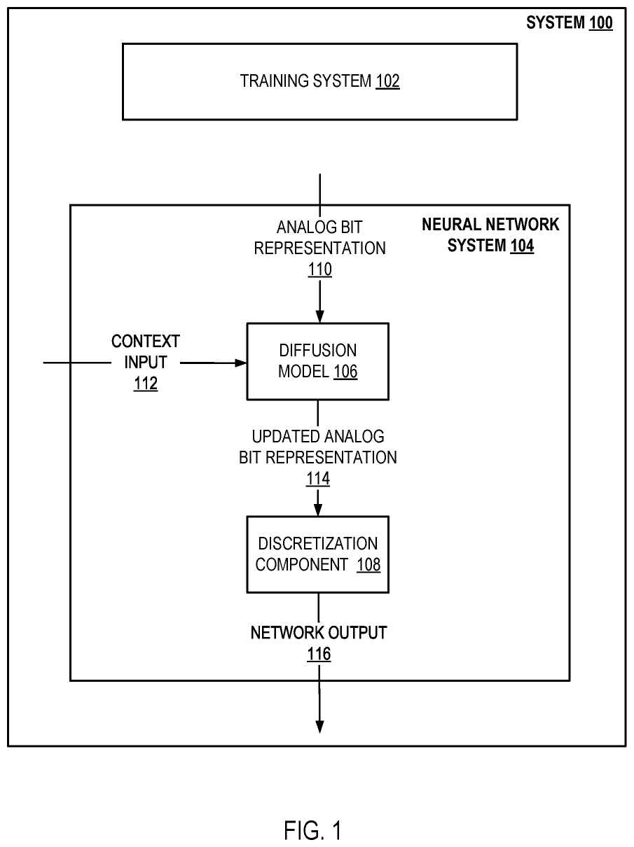

FIG. 1 shows an example system 100. The system 100 is an example of a system in which the systems, components, and techniques described below are implemented.

The system 100 is configured to generate discrete data outputs using a diffusion machine learning model.

The system 100 includes a training system 102 and a neural network system 104.

The neural network system 104 includes a diffusion model 106 and a discretization component 108.

After the diffusion model 106 has been trained, e.g., by training system 102, the neural network system 104 uses the diffusion model 106 and the discretization component 108 to generate a network output 116 by processing (e.g., sampling) an analog bit representation 110 and, optionally, a context input 112.

That is, when the context input 112 is used, the neural network system 104 obtains the context input 112 and uses the context input 112 to generate a network output 116 that has one or more desired properties characterized by the context input 112.

Generally, the network output 116 includes one or more output tokens that are each selected from a discrete vocabulary of output tokens. Thus, each output token has a discrete index that uniquely identifies the token within the vocabulary. For example, if the vocabulary includes 512 tokens, each token can be assigned a respective integer in the range of [0,511] or [1,512].

Thus, generating each of the tokens in the network output 116 requires selecting one of the tokens from the discrete vocabulary or selecting one of the discrete indices of the tokens in the discrete vocabulary. This is in contrast to generating a continuous value which can take any value in a specified range and is constrained only by the precision of the numerical format used by the system 104.

In order to generate the network output 116, the neural network system 104 initializes an analog bit representation 110 of the network output 116.

Generally, the analog bit representation 110 includes a respective set of numeric values for each of the output tokens of the network output 116. The numeric values for each of the output tokens include a respective continuous value for each binary value in a binary representation of the output token. The continuous values can be, e.g., initialized to values sampled from a noise distribution, e.g., a normal distribution or another appropriate fixed distribution that does not depend on the context input 112 or the network output 116.

For example, the binary representation of a given token can be a base-2, binary encoding of the index of the token in the vocabulary (e.g., using binary bits). Thus, each binary value in the binary representation represents one of the binary bits in the base-2 encoding of the index.

As another example, the binary representation of a given token can be a one-hot encoding of the index of the token in the vocabulary (e.g., using binary bits). Thus, each binary value in the binary representation corresponds to one of the indices and is a one only for the index of the token and a zero for all other indices.

The neural network system 104 then generates the network output 116 by using the diffusion model 106 to process the analog bit representation 110.

The neural network system 104 processes the analog bit representation 110 to generate the network output 116 by updating the analog bit representation 110 at each iteration of a reverse diffusion process using the diffusion model 106.

In particular, to generate the network output 116, the neural network system 104 uses the diffusion model 106 to perform a reverse diffusion process across multiple iterations.

The diffusion model 106 can be any appropriate diffusion neural network that has been trained, e.g., by the training system 102 or another training system, to, at any given update iteration, process a diffusion input for the update iteration that includes the current data item (as of the update iteration) to generate a denoising output for the update iteration. For example, the diffusion model 106 can be a convolutional neural network, e.g., one that has a U-Net architecture, or a self-attention neural network, e.g., one that has a Transformer encoder architecture.

At each update iteration, the neural network system 104 uses the denoising output generated by the diffusion model 106 to update the current analog bit representation 110 as of the update iteration.

In some implementations, the denoising output is an estimate of the noise component of the current analog bit representation 110, i.e., the noise that needs to be combined with, e.g., added to or subtracted to, a final analog bit representation that can be mapped to the network output 116 to generate the current analog bit representation 110.

In some other implementations, the denoising output is an estimate of the final analog bit representation given the current analog bit representation 110, i.e., an estimate of the analog bit representation that would result from removing the noise component of the current analog bit representation 110.

In particular, the current analog bit representation 110 at an update iteration corresponding to a time step t can be represented as xₜ=\sqrt{γ(t)}x₀+\sqrt{1−γ(t)}ϵ, where t is the time step, γ(t) is a monotonically decreasing function from 1 to 0 that depends on t, x₀ is the final analog bit representation, and ϵ is the noise component that has been sampled from an appropriate noise distribution, e.g., ϵ˜N(0,1). Thus, the denoising output can either be an estimate of ϵ or an estimate of x₀.

Generally, at each update iteration, the system 104 generates an estimate of x₀ using the denoising output for the update iteration, e.g., by either directly using the estimate of the diffusion model or by using the above equation to determine the estimate from the estimate of ϵ generated by the diffusion model.

At each update iteration other than the last iteration, the system 104 can then apply a diffusion sampler to the estimate to generate the updated analog bit representation for the iteration. The system can use any of a variety of diffusion samplers, e.g., the DDIM sampler, the DDPM sampler, and so on. At the last update iteration, the system 104 can use the estimate of x₀ as the updated analog bit representation to generate the network output 116.

In some examples, the neural network system 104 can use self-conditioning to modify the input to the diffusion model 106 at each update iteration to generate the denoising output. In particular, the system can include, as part of the input to the diffusion model 106, the estimate of x₀ generated using the diffusion model 106 at the preceding iteration.

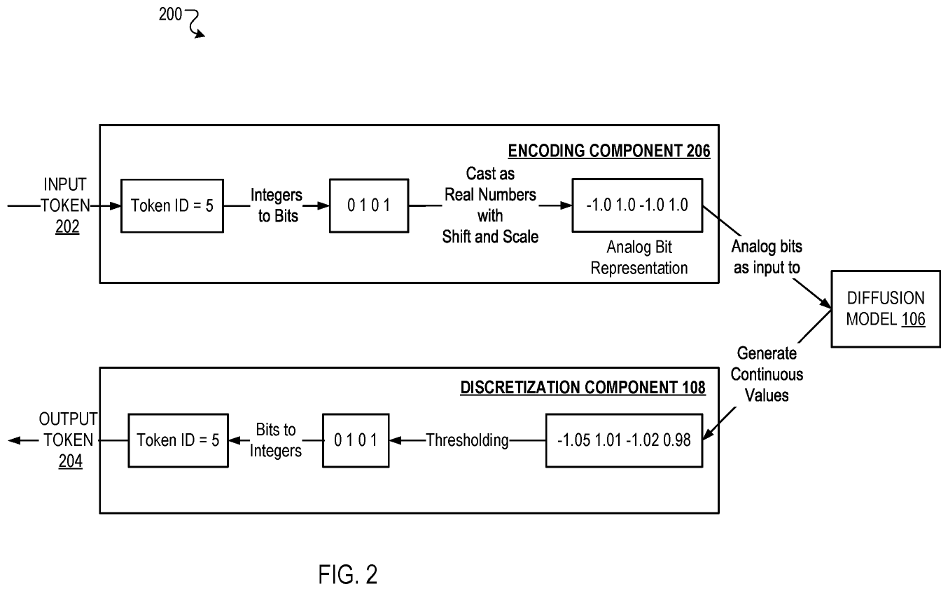

Performing the update iterations is described in more detail below with reference to FIGS. 2-4.

While performing the updating iterations, the system 104 performs the reverse diffusion process in continuous space, i.e., without applying any constraints to the values in the analog bit representation other than those imposed by the numerical format used by the system 100. Thus, the system 104 does not constrain the values in the analog bit representation to be binary values at any point during the reverse diffusion process.

After the last updating iteration, the neural network system 104 has generated an updated analog bit representation 114 (e.g., a final analog bit representation). The updated analog bit representation 114 includes a respective set of continuous numeric values for each of the output tokens in the network output 116 that are finalized after the one or more updating iterations. Because the reverse diffusion process was performed in the continuous space, the values in the analog bit representation 114 can include non-binary values.

The neural network system 104 then uses the discretization component 108 to generate the network output 116 by processing the updated analog bit representation 114.

In some implementations, the discretization component 108 generates a binary representation of each output token by generating a corresponding binary value from each updated continuous value. The discretization component 108 then generates the network output 116 by sampling and decoding the binary representation of each output token to map the binary representation of each output token into a token from the vocabulary of tokens as described in further detail with reference to FIG. 2.

The system can condition the network output 116 on a network input, i.e., the context input 112, in any of a variety of ways. For example, when initializing the analog bit representation of the network output, the system can generate a respective set of continuous numeric values representing each of the input tokens in the network input, and then include the values in the analog bit representation, such that the analog bit representation includes the respective sets of continuous numeric values representing each of the input tokens and the respective sets of continuous numeric values representing each of the output tokens. The system can then constrain the values corresponding to the network input to be fixed throughout the reverse diffusion process and disregard the values corresponding to the network input when generating the binary representation described above.

As another example, the system can process the network input using an encoder neural network to generate an encoded representation of the network input, and at each update iteration, condition the diffusion model 106 on the encoded representation of the network input. The encoder neural network can be any appropriate neural network that can be trained to encode a network input, e.g., a convolutional neural network, a language modeling neural network, e.g., a Transformer neural network, a recurrent neural network, or a fully-connected neural network. Similarly, the diffusion model 106 can be conditioned on the encoded representation of the network input in any of a variety of ways. For example, the diffusion model 106 can include one or more cross-attention layers that each apply cross-attention into the encoded representation. As another example, the diffusion model 106 can include one or more layers that are conditioned on the encoded representation in a different way, e.g., through gating or through a FiLM mechanism.

Prior to using the neural network system 104 for sampling, the system 100 can use the training system 102 to train the diffusion model 106 of the neural network system 104, as described in further detail with reference to FIG. 2. That is, the training system 102 trains the diffusion model 106 on training data that includes multiple training network outputs and, optionally, a respective training context input for each training network output.

The system 100 can be used to generate any of a variety of types of network outputs 116 conditioned on any of a variety of types of context inputs 112.

For example, the system 100 can perform a natural language generation or natural language modeling task conditioned on the context input 112, i.e., generate a network output 116 that includes text tokens selected from a vocabulary of text tokens, e.g., tokens representing any of words, sub-words, characters, numerical symbols, punctuation, and so on. For example, the system 100 can perform computer code generation, where the network output 116 is computer code in a programming language and the context input 112 is, e.g., text or computer code or both. As another example, the system 100 can be part of a chatbot or other conversational system that generates natural language text in response to user inputs, e.g., in response to user text inputs, audio inputs, image inputs, or some combination of the above. As another example, the system 100 can perform image generation, where the intensity values of the pixels are constrained to be discrete, e.g., to be 4-bit or 8-bit values. In this example, the context input 112 can be, e.g., text or audio describing the image, another image to be modified, or some combination. As yet another example, the system 100 can perform a computer vision task, where the context input 112 is an image and the network output 116 is a discrete, structured output for the image. For example, the structured output can be a segmentation output, e.g., a semantic segmentation output, an instance segmentation output, or a panoptic segmentation output. As another example, the system 100 can perform audio generation, where the amplitude values of the audio are constrained to be discrete, e.g., to be 4-bit or 8-bit values.

FIG. 2 shows an example of the operation of the system 100 at inference and at training.

In particular, at inference time, the system 100 uses the trained diffusion model 106 to generate output tokens representing discrete data.

In particular, FIG. 2 shows how, after the last updating iteration, the trained diffusion model 106 outputs the updated analog bit representation. For ease of illustration, FIG. 2 only shows the setoff continuous values for an example output token 204 in the network output.

As described above, the updated analog bit representation includes a respective set of updated continuous values for each of the output tokens. Each of the continuous numeric values for a given token corresponds to a binary value (e.g., 0 or 1) in a binary representation of the token. Because the diffusion model 106 operates in a continuous space to generate the updated analog bit representation, the values of the updated analog bit representation can take values that are not equal to one of the two binary values.

In this example, the continuous values include −1.05, 1.01, −1.02, 0.98, none of which are a 0 or 1.

In some examples, the discretization component 108 performs a thresholding operation on each of the continuous values to generate the binary representation of the output token 204.

The discretization component 108 performs the thresholding operation by quantizing each continuous value using a threshold to generate the corresponding base-2 binary value of the binary representation.

In some cases, the discretization component 108 uses shifting and scaling when performing the threshold operation by thresholding any value less than or equal to zero as zero and any value greater than zero as 1. For example, the discretization component 108 thresholds 1.01 to generate a value of 1 and −1.02 to generate a value of 0.

The discretization component 108 then decodes the binary representation to generate an output token 204. The discretization component 108 can decode the binary representation based on whether the binary representation is encoded through base-2 encoding or one hot encoding.

In some examples, the binary representation represents a token identification (ID) integer index associated with a vocabulary of output tokens, as described above. In this example, the token ID index of the output token is 5, such that the index of the output token in the vocabulary is index 5. That is, the system decodes the bits 0101 to the integer 1 using base-2 decoding, i.e., by converting base-2 binary into an integer.

Alternatively, in the case of one-hot encoding, for each output token, the discretization component 108 performs an argmax procedure on the vector of continuous values generated by the trained diffusion model 106 for the output token or on the binary representation of the output token. In the latter case, the argmax procedure takes the binary representation as input and the argmax procedure outputs the slot (e.g., index) of the non-zero value in the binary representation. The discretization component 108 sets the index of the non-zero value to the index of the output token 204 of the corresponding vocabulary. In the former case, the argmax procedure takes the vector of continuous values as input and the argmax procedure outputs the slot (e.g., index) of the largest value in the vector. The discretization component 108 sets the index of the largest value to the index of the output token 204 of the corresponding vocabulary.

Additionally, FIG. 2 shows an example of how the system 100 trains the diffusion model 106 to generate continuous values from discrete data.

In particular, FIG. 2 shows an example of training the diffusion model on a training output that includes one or more input tokens 202, one of which is an input token 202 that has a token ID of 5 in the vocabulary.

The system 200 uses the encoding component 206 to process (e.g., encode) the input token 202 and to generate an analog bit representation (e.g., analog bits) that corresponds to the input token 202. The encoding component 206 assigns a discrete value, such as a token ID integer, to the input token 202.

The encoding component 206 converts the discrete value, such as a token ID, to a binary bit representation through an encoding process. For example, the input token ID of 5 is converted to the binary bits of 0101. The encoding component 206 can encode the discrete value representing the input token 202 through base-2 encoding (e.g., binary bits) as shown in the example,

Alternatively, the encoding component 206 can encode the discrete value representing the input token 202 using a one-hot encoding process. In one-hot encoding, the encoding component 206 generates a vector using the discrete value, and the vector is the same length as the size of the vocabulary associated with the input token 202. The vector has a single slot with a non-zero value (e.g., 1), representing the discrete value, and the rest of the slots of the vector are set to zero.

The encoding component 206 generates the analog bit representation of the input token 202 by casting each of the binary values of the binary bit representation as a floating point number (e.g., −1.0 and 1.0).

Optionally, the encoding component 206 shifts and scales each of the binary bits to generate the floating point numbers corresponding to each binary bit.

For example, the binary bit of 0 in the binary representation is shifted and scaled to −1.0, and the binary bit of 1 in the binary representation is shifted and scaled to 1.0. Shifting and scaling the binary bits allows for decreased error in decoding the analog bit representation during sampling. When the system employs shifting and scaling during training, the system can also incorporate shifting and scaling into the thresholding operation as described above.

The analog bit representation of the training network output is used to train the diffusion model 106.

The system 200 trains the diffusion model 106 using the training system by processing the analog bit representations of multiple input tokens 202 by adding noise to the analog bit representations and then de-noising the analog bit representation to generate an updated analog bit representation, i.e., by performing one of the update iterations described above with a randomly sampled time step t.

The system can then train the diffusion model 106 on a loss function that measures errors in denoising outputs. For example one example of the loss function can be:

$${L}_{{x}_{0}} = {E}_{t \sim U ( 0 , T ) , ϵ \sim N ( 0 , 1 )} {‖ f ( \sqrt{γ ( t )} {x}_{0} + \sqrt{1 - γ ( t )} ϵ , t ) - {x}_{0} ‖}^{2}$$

where t is the randomly sampled time step, γ(t) is a monotonically decreasing function from 1 to 0, t˜U(0,T), and ϵ˜N(0,1).

As another example, the system can train the diffusion model using other loss functions that measure errors between estimates generated from denoising outputs and the corresponding analog bit representations of training network inputs, e.g., sigmoid cross-entropy losses or softmax cross-entropy losses.

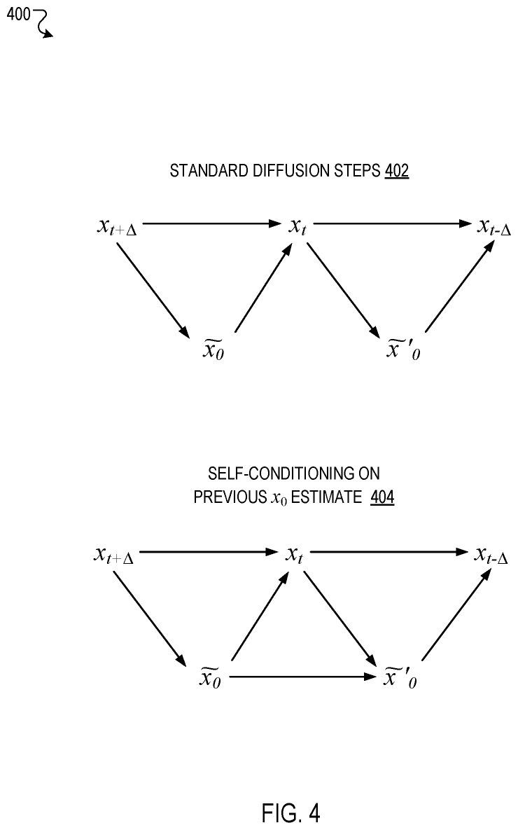

In some examples, the diffusion input includes the analog bit representation as of the update iteration and the prediction of the updated analog bit representation generated by the diffusion model 106 at a previous (e.g., preceding) update iteration, which will be described in further detail with reference to FIG. 4. Thus, in these examples, the system can modify the training to incorporate estimates generated at previous update iterations into the diffusion inputs. That is, the system can first process the training network input as described above to generate an initial estimate (with a diffusion input that includes a pre-determined or random initial estimate) and then use the initial estimate to generate the diffusion input from which the loss above or other appropriate loss will be computed.

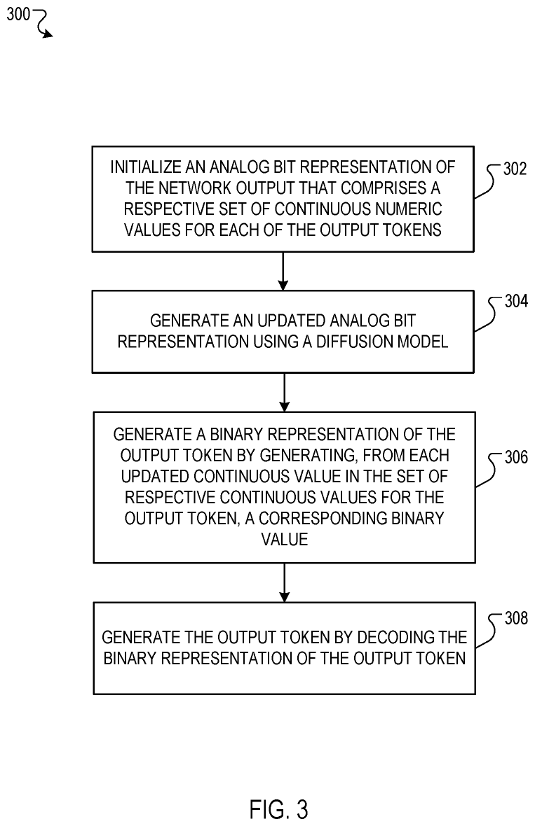

FIG. 3 is a flow diagram for generating discrete data using a diffusion model. For convenience, the process 300 will be described as being performed by a system of one or more computers located in one or more locations. For example, a computing device system, e.g., the system 100 of FIG. 1, appropriately programmed in accordance with this specification, can perform the process 300.

The system initializes an analog bit representation of the network output (302).

Generally, the network output includes one or more output tokens that are each selected from a discrete vocabulary that includes a fixed number of output tokens.

The analog bit representation includes a respective set of continuous numeric values for each of the output tokens. Generally, the numeric value is referred to as “continuous” because during the reverse diffusion process, the numeric value can take any value in a specified range constrained only by the precision of the numerical format used by the system.

The system generates an updated analog bit representation using a diffusion model (304). In particular, the system iteratively updates the analog bit representation to generate the updated analog bit representation. The updated analog bit representation includes a respective set of updated continuous numeric values for each of the output tokens.

To generate the updated analog bit representation, the system uses the diffusion model to update the analog bit representation at each of multiple iterations as described above.

The system generates a binary representation of each output token by generating a binary value from each updated continuous numeric value in the updated analog big representation after the last updating iteration (306), e.g., using thresholding as described above.

The system generates the output tokens by decoding the binary representation of each output token (308). For example, the system can use base-2 decoding to convert each binary representation of each output token into an integer or can use one-hot decoding to convert each binary representation into an integer representing an index in a vocabulary.

FIG. 4 is a diagram of diffusion model implementations. For convenience, the diagram 400 will be described as being implemented by a system of one or more computers located in one or more locations. For example, a computing device system, e.g., the system 100 of FIG. 1, appropriately programmed in accordance with this specification, can implement the processes included in the diagram 400.

The diagram 400 includes standard reverse diffusion steps 402 for a standard diffusion model procedure and a self-conditioning on a previous estimate approach 404 for a diffusion model.

The diffusion model refines from a current prediction of the analog bit representation to the updated analog bit representation. For example, a trained diffusion model can initialize an image made up of noise, and the trained diffusion model can perform updating an analog bit representation of the image to generate the updated analog bit representation.

The trained diffusion model can be implemented into the system 100 described above. At multiple update iterations, the trained diffusion model performs a reverse transition from a previous estimate of the analog bit representation to a current estimate of the analog bit representation. After the final update iteration, the diffusion model has mapped noise, represented by ϵ, from a known prior noise distribution to a final output, the updated analog bit representation, represented by x₀, from a data distribution. Regardless of the implementation, the diffusion model assumes a continuous data space and state space for performing the reverse transition.

During sampling, the diffusion model follows a series of reverse diffusion steps (standard diffusion steps 402) to predict the updated analog bit representation (x₀). The diffusion model starts at an initial estimate of the analog bit representation, represented by x_{t+Δ} and the diffusion model performs multiple reverse transitions (e.g., multiple update iterations) to refine from the estimate of the analog bit representation to the updated analog bit representation.

For example, the system uses the diffusion model to generate an estimate of the updated analog bit representation [symbol] from the current analog bit representation x_{t+Δ} and the system updates the initial estimate of the analog representation x_{t+Δ} to the current estimate of the analog bit representation (xₜ) using the estimate of the updated analog bit representation ( [symbol] ), e.g., by applying a diffusion sampler to the updated analog bit representation.

At the next updating iteration, the system uses the diffusion model to generate a current estimate of the updated analog bit representation ( [symbol] ) from the current analog bit representation xₜ. The system then transitions from xₜ to the next estimate of the analog bit representation (x_{t-Δ}) using the current estimate of the updated analog bit representation ( [symbol] ), where Δ is the time interval between time steps corresponding to the update iterations.

In some examples, regardless of the implementation, the system can perform self-conditioning on a previous estimate of the updated analog bit representation (e.g., self-conditioning on a previous estimate 404) to transition from the noise state to the clean state. The diffusion model can use a previous x₀ estimate, such as ( [symbol] ), to generate the current estimate of the updated analog bit representation, such as ( [symbol] ), at each update iteration of the sampling process, e.g., the diffusion input at each update iteration includes the previous estimate of the updated analog bit representation.

For example, the system can include the previous estimate in the diffusion input for the current update iteration by concatenating the current analog bit representation as of the update iteration with the previous estimate (generated from the denoising output of the diffusion model at the preceding update iteration).

In this implementation, using the previous estimate of the updated analog bit representation can improve the sample quality of the diffusion model because the diffusion model can leverage previous update iterations to more efficiently perform a current update iteration. Using the previous estimates can improve the quality of the current estimate of the updated analog bit representation, which can improve the generation of the network output.

Whether using self-conditioning or not, the diffusion input can also optionally include additional information at any given update iteration. For example, the diffusion input can include an encoded representation of the context input. As another example, the diffusion input can include data identifying the time step t corresponding to the current update iteration.

Additionally, the system can implement asymmetric time intervals to improve the quality of the updated analog bit representation.

As shown in the equations above, the time step t directly impacts the state transitions and the loss function of the diffusion model, i.e., because γ(t) is a function of t and defines how the noise component is combined with the current representation at any given time step.

In some examples, the diffusion model uses symmetric time intervals (Δ) to perform the reverse transition at the multiple update iterations. Symmetric time intervals are associated with using the same interval between any two time steps for any two consecutive update iterations.

In some other examples, the diffusion model can use asymmetric time intervals. Asymmetric time intervals can be different for each update iteration. For example, when using asymmetric time intervals, the diffusion model can use a relatively large time step for performing the reverse transition, which can improve the denoising quality of the sampling process. In particular, the diffusion model uses asymmetric time intervals t′ for the sampling process f(xₜ, t′):

$${t}^{′} = t + ξ$$

where ξ is a small non-negative time difference parameter.

In this implementation, using asymmetric time intervals during sampling can reduce the noise of the analog bit representation associated with the output tokens. For example, the diffusion model can update the output tokens of an image by using different time intervals at each of the state transitions, which can result in the output tokens being associated with less noise (e.g., a reduced number of noisy image pixels).

This specification describes the self-conditioning on previous estimates and asymmetric time intervals as being implemented by a system that uses a diffusion model to generate discrete data.

However, the above processes can be used in other diffusion models that are included in other systems, e.g., systems that generate network outputs with continuous values. That is, other diffusion models can use self-conditioning, asymmetric time intervals, or both when generating network outputs in the continuous data space. For example, a diffusion model can generate continuous values corresponding to amplitude measurements as part of speech or other audio generation, or a diffusion model can generate continuous values corresponding to pixel intensity values of an image as part of image generation.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for generating a network output comprising one or more output tokens, the method comprising:
initializing an analog bit representation of the network output that comprises a respective set of continuous numeric values for each of the output tokens;
generating an updated analog bit representation that comprises a respective set of updated continuous numeric values for each of the output tokens, the generating comprising, at each of a plurality of update iterations:
processing a diffusion input comprising the analog bit representation using a diffusion machine learning model to update the analog bit representation; and
for each output token:
generating a binary representation of the output token by generating, from each updated continuous value in the set of respective continuous values for the output token, a corresponding binary value; and
generating the output token by decoding the binary representation of the output token.

2. The method of claim 1, wherein the network output is conditioned on a network input comprising one or more input tokens, wherein initializing the analog bit representation of the network output further comprises:
generating a respective set of continuous numeric values representing each of the input tokens, and wherein the analog bit representation comprises the respective sets of continuous numeric values representing each of the input tokens and the respective sets of continuous numeric values representing each of the output tokens.

3. The method of claim 1, wherein the network output is conditioned on a network input, wherein the method further comprises:
processing the network input using an encoder neural network to generate an encoded representation of the network input; and
wherein at each update iteration, the diffusion model is conditioned on the encoded representation of the network input.

4. The method of claim 1, wherein generating the binary representation of the output token comprises quantizing each continuous value using a threshold to generate the corresponding binary value.

5. The method of claim 1, wherein processing the diffusion input comprising the analog bit representation using a diffusion machine learning model to update the analog bit representation further comprises, at each of the plurality of iterations:
processing a diffusion input for the update iteration that comprises the analog bit representation as of the update iteration using the diffusion machine learning model to generate a denoising output that defines an update to the analog bit representation; and
updating the analog bit representation as of the update iteration using the denoising output.

6. The method of claim 5, wherein the diffusion input for the update iteration comprises (i) the analog bit representation as of the update iteration and (ii) the denoising output generated by the diffusion machine learning model at a preceding update iteration.

7. The method of claim 5, wherein the diffusion input for the update iteration comprises an identifier for a time step corresponding to the update iteration, and wherein time intervals between the time steps corresponding to the update iterations are asymmetric.

8. The method of claim 5, wherein the denoising output is an estimate of a noise component of a final analog bit representation.

9. The method of claim 1, wherein, for each output token, the set of binary values has a respective value for each output of a vocabulary of output tokens and includes only one non-zero value.

10. The method of claim 9, further comprising:
setting the output token to be the output token from the vocabulary that corresponds to the non-zero value.

11. The method of claim 1, wherein, for each output token, the binary representation of the output token is a representation of a number in a base-2 number system.

12. The method of claim 11, further comprising:
setting the output token to be an output token from a vocabulary that is identified by the number in the base-2 number system.

13. A system comprising:
one or more computers; and
one or more storage devices storing instructions that, when executed by the one or more computers, cause the one or more computers to perform operations comprising:
initializing an analog bit representation of the network output that comprises a respective set of continuous numeric values for each of the output tokens;
generating an updated analog bit representation that comprises a respective set of updated continuous numeric values for each of the output tokens, the generating comprising, at each of a plurality of update iterations:
processing a diffusion input comprising the analog bit representation using a diffusion machine learning model to update the analog bit representation; and
for each output token:
generating a binary representation of the output token by generating, from each updated continuous value in the set of respective continuous values for the output token, a corresponding binary value; and
generating the output token by decoding the binary representation of the output token.

14. The system of claim 13, wherein the network output is conditioned on a network input comprising one or more input tokens, wherein initializing the analog bit representation of the network output further comprises:
generating a respective set of continuous numeric values representing each of the input tokens, and wherein the analog bit representation comprises the respective sets of continuous numeric values representing each of the input tokens and the respective sets of continuous numeric values representing each of the output tokens.

15. The system of claim 13, wherein the network output is conditioned on a network input, wherein the method further comprises:
processing the network input using an encoder neural network to generate an encoded representation of the network input; and
wherein at each update iteration, the diffusion model is conditioned on the encoded representation of the network input.

16. The system of claim 13, wherein generating the binary representation of the output token comprises quantizing each continuous value using a threshold to generate the corresponding binary value.

17. One or more non-transitory computer storage media encoded with computer program instructions that when executed by one or more computers cause the one or more computers to perform operations comprising:
initializing an analog bit representation of the network output that comprises a respective set of continuous numeric values for each of the output tokens;
generating an updated analog bit representation that comprises a respective set of updated continuous numeric values for each of the output tokens, the generating comprising, at each of a plurality of update iterations:
processing a diffusion input comprising the analog bit representation using a diffusion machine learning model to update the analog bit representation; and
for each output token:
generating a binary representation of the output token by generating, from each updated continuous value in the set of respective continuous values for the output token, a corresponding binary value; and
generating the output token by decoding the binary representation of the output token.

18. The one or more non-transitory computer storage media of claim 17, wherein the network output is conditioned on a network input comprising one or more input tokens, wherein initializing the analog bit representation of the network output further comprises:
generating a respective set of continuous numeric values representing each of the input tokens, and wherein the analog bit representation comprises the respective sets of continuous numeric values representing each of the input tokens and the respective sets of continuous numeric values representing each of the output tokens.

19. The one or more non-transitory computer storage media of claim 17, wherein the network output is conditioned on a network input, wherein the method further comprises:
processing the network input using an encoder neural network to generate an encoded representation of the network input; and
wherein at each update iteration, the diffusion model is conditioned on the encoded representation of the network input.

20. The one or more non-transitory computer storage media of claim 17, wherein generating the binary representation of the output token comprises quantizing each continuous value using a threshold to generate the corresponding binary value.
